(19) United States
(12) Patent Application Publication
(10) Pub. No.: US 2026/0260959 A1
(43) Pub. Date: Sep. 3, 2026

(54) METHODS AND DEVICES FOR IMPROVING CHARGE AND DISCHARGE RATES OF BATTERIES

(71) Applicant: Electrovaya Inc., Mississauga (CA)

(72) Inventors: Rajshekar DasGupta, Oakville (CA); Harry Young, Guelph (CA); Elmira Memarzadeh Lotfabad, Mississauga (CA); William Keith Baker, Inglewood (CA); Abdolhassan Shahrbanoozadeh, Brampton (CA)

(21) Appl. No.: 19/653,924

(22) Filed: Apr. 21, 2026

Related U.S. Application Data
(63) Continuation of application No. PCT/IB2024/060163, filed on Oct. 16, 2024.
(60) Provisional application No. 63/603,074, filed on Nov. 27, 2023.

(51) Int. Cl. H01M 10/63; H01M 10/615; H01M 10/6571; H01M 50/271; H01M 50/507; H01M 10/625

(52) U.S. Cl. CPC H01M 10/63; H01M 10/615; H01M 10/6571; H01M 50/271; H01M 50/507; H01M 10/625

(57) ABSTRACT

An electrochemical energy storage device and a method of operating the same are described. The electrochemical energy storage device may include one or more electrochemical cells and a heating module coupled to, and configured to regulate a temperature of, the electrochemical cells. The heating module may include an internal control mechanism configured to regulate the temperature of the electrochemical cells within a predetermined temperature range. The heating module may include a bus bar physically coupled to a heating element that can be controlled via electronically operated switches, such as, solid state or mechanical relays. In various embodiments, the electrochemical cells may be regulated to maintain a minimum temperature during which charging, or discharging, can occur at a maximal rate.

### CROSS-REFERENCE TO RELATED APPLICATIONS

The present application is a continuation of International Application No. PCT/IB2024/060163, filed October 16, 2024, which claims priority to U.S. Patent Application No. 63/603,074, filed November 27, 2023, all of which are incorporated by reference herein in their entirety.

### FIELD OF INVENTION

The disclosure relates to electrochemical energy storage devices including rechargeable lithium-ion batteries, and more particularly related to methods and devices for improving charging and discharging of batteries in extreme environments.

### BACKGROUND

The demand for lithium-based battery technologies with improved capacity, cycle life, and superior charging and discharging rates is ever-increasing along with the upticks in the rapid adoption of passenger and commercial electric vehicles. Rising along with the commercial demand is the need for lithium-ion batteries that can be used in extreme environments, e.g., in freezing conditions, including a freezer warehouse where a battery-operated forklift may be used continuously. To operate battery electric vehicles in such low temperatures, for example, the batteries need to be able to perform and remained operational when subjected to the cold environment for an extended amount of time. When the vehicles reside in the cold environment for a long period, the low temperatures of the batteries may require the batteries to be derated when charging or discharging. In such cases, the batteries would need to be used at sub-optimal charging and discharging rates because the battery chemistry would not allow charging and discharging at maximum rates achieved at temperatures around 20-25 ºC. In order to operate the batteries at maximum charge and discharge rates in such environments, it may be necessary to keep the batteries at a temperature above where derating is required, i.e., around 20 ºC. Therefore, there is a need for a battery management system that can work with existing battery technologies so that the batteries can be conditioned or sustained at their optimal performance level in such extreme environments.

### BRIEF DESCRIPTION OF THE DRAWINGS

For a more complete understanding of the principles disclosed herein, and the advantages thereof, reference is now made to the following descriptions taken in conjunction with the accompanying drawings, in which:

FIG. 1 illustrates an embodiment of an electrical energy storage device with a built-in battery management system, in accordance with various embodiments.

FIG. 2 illustrates an embodiment of an electrical energy storage device as a battery module, in accordance with various embodiments.

FIG. 3 illustrates an embodiment of a heating module for use within an electrical energy storage device, in accordance with various embodiments.

FIG. 4 illustrates a schematic circuit diagram of an electrical energy storage device depicting interconnections between a plurality of electrochemical cells and heaters of a heating module, in accordance with various embodiments.

FIG. 5 illustrates an example schematic diagram of a control circuit in a battery management system of an electrical energy storage device, in accordance with various embodiments.

FIG. 6 illustrates a method of operating an electrical energy storage device, in accordance with various embodiments.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

The following shall be a detailed description of the drawings which are given for the purposes of illustrating the preferred embodiments of the present invention, and not for the purpose of limiting the same. In accordance with one or more embodiments, an electrical energy storage device with a built-in battery management system comprising a heating module and a method of operating the energy storage device are disclosed. The electrical energy storage device is also referred to herein as a battery pack, a battery unit, a battery module, or simply, a battery. The disclosed electrical energy storage device may be used to power any vehicle, including, but not limited to, a forklift, a bus, etc., in an extreme temperature environment, such as in a freezer warehouse.

In one or more embodiments, the disclosed electrical energy storage device with a built-in battery management system may include one or more electrochemical cells and a heating module coupled to the electrochemical cells. In accordance with one or more embodiments, the built-in battery management system comprises the heating module and is configured to control the heating module. The heating module may be configured to regulate a temperature of the electrochemical cells, in some embodiments. In one or more embodiments, the heating module may be configured to function as an internal control mechanism to regulate the temperature of the electrochemical cells to be within a predetermined temperature range. In some embodiments, the heating module may be configured to limit a temperature drop or can be configured as a trigger to turn on the heating when the temperature drops below a certain preset temperature or goes outside of the preset temperature range. In some embodiments, the preset or predetermined temperature range can have a minimum preset temperature and a maximum preset temperature, within which the heating module can function or regulate the temperature of the electrochemical cells.

In one or more embodiments, the heating module may include a temperature sensor disposed near one or more of the electrochemical cells. The temperature sensor may be used to monitor a temperature of the electrochemical cells or the electrical energy storage device. In some embodiments, several temperature sensors can be placed throughout the electrical energy storage device or near each of the electrochemical cells. This will allow monitoring of the electrical energy storage device or the electrochemical cells more discretely, reliably, and/or correctly, e.g., during normal operations in normal environments or when the temperature of the electrical energy storage device or the electrochemical cells goes to the extremes, such as, during harsh winters or hottest summer months.

In one or more embodiments, the electrical energy storage device may include an enclosure to enclose the electrical energy storage device. The enclosure may be configured to house the electrochemical cells and the heating module, and any accompanying miscellaneous and ancillary electrical or electronic components. In some embodiments, the internal control mechanism of the heating module is independent of an external control from outside the enclosure.

In one or more embodiments, the heating module may include a bus bar physically coupled to a heating element. In some embodiments, a plurality of bus bars may be used to heat one or more electrochemical cells or the electrical energy storage device. In one or more embodiments, the plurality of bus bars may connect the electrochemical cells together in series. In some embodiments, the plurality of bus bars may be intimately connected to the electrodes of the electrochemical cells of the electrical energy storage device. The heat applied to the bus bars may be channel into one or more electrochemical cells or heat up a portion or an entirety of the electrical energy storage device.

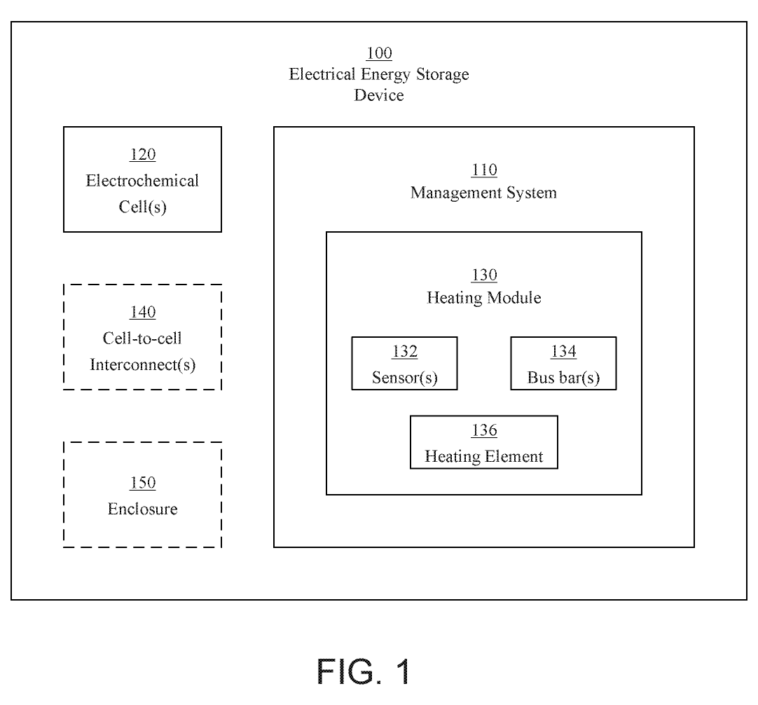

FIG. 1 illustrates an embodiment of an electrical energy storage device 100 with a built-in battery management system 110, in accordance with various embodiments. As illustrated in FIG. 1, the electrical energy storage device 100 with the built-in battery management system 110 may include one or more electrochemical cells 120 and a heating module 130 coupled to the electrochemical cells 120. In one or more embodiments, the built-in battery management system 110 comprises the heating module 130 and is configured to control the heating module 130.

In one or more embodiments, the heating module 130 may be configured to regulate a temperature of the electrochemical cells. In one or more embodiments, the heating module 130 may be configured to function as an internal control mechanism to regulate the temperature of the electrochemical cells 120 to be within a predetermined temperature range. In one or more embodiments, the heating module 130 may be configured to regulate the temperature of one or more electrochemical cells 120, a portion of the electrochemical cells 120, or all of the electrochemical cells 120. In some embodiments, the heating module 130 may be configured to limit a temperature drop or can be configured as a trigger to turn on the heating when the temperature drops below a certain preset temperature or goes outside of the preset temperature range. In some embodiments, the preset or predetermined temperature range can have a minimum preset temperature and a maximum preset temperature. In various embodiments, the heating module 130 can be configured to function or regulate the temperature of the electrochemical cells 120 within such minimum preset temperatures and maximum preset temperatures.

In various embodiments, the minimum preset temperature can be about -10 ºC, about -9 ºC, about -8 ºC, about -7 ºC, about -6 ºC, about -5 ºC, about -4 ºC, about -3 ºC, about -2 ºC, about -1 ºC, about 0 ºC, about 1 ºC, about 2 ºC, about 3 ºC, about 4 ºC, about 5 ºC, about 6 ºC, about 7 ºC, about 8 ºC, about 9 ºC, about 10 ºC, about 11 ºC, about 12 ºC, about 13 ºC, about 14 ºC, about 15 ºC, about 16 ºC, about 17 ºC, about 18 ºC, or about 19 ºC.

In various embodiments, the maximum preset temperature can be about 10 ºC, about 11 ºC, about 12 ºC, about 13 ºC, about 14 ºC, about 15 ºC, about 16 ºC, about 17 ºC, about 18 ºC, about 19 ºC, about 20 ºC, about 21 ºC, about 22 ºC, about 23 ºC, about 24 ºC, about 25 ºC, about 26 ºC, about 27 ºC, about 28 ºC, about 29 ºC, about 30 ºC, about 31 ºC, about 32 ºC, about 33 ºC, about 34 ºC, about 35 ºC, about 36 ºC, about 37 ºC, about 38 ºC, or about 39 ºC.

In one or more embodiments, the heating module 130 may include a temperature sensor 132 disposed near one or more of the electrochemical cells 120. The temperature sensor 132 may be used to monitor a temperature of the electrochemical cells 120 or the electrical energy storage device 100. In some embodiments, several temperature sensors 132 can be placed throughout the electrical energy storage device 100 or near each of the electrochemical cells 120. This will allow monitoring of the electrical energy storage device 100 or the electrochemical cells 120 more discretely, reliably, and/or correctly, e.g., during normal operations in normal environments/temperatures or when the temperature of the electrical energy storage device 100 or the electrochemical cells 120 reaches the extremes, such as, during harsh winters or hottest summer months.

In one or more embodiments, the heating module 130 may include a bus bar 134 physically coupled to a heating element 136. In one or more embodiments, the heating element 136 may include a resistive wire or any suitable means of producing heat. In some embodiments, a plurality of bus bars 134 may be used to heat one or more electrochemical cells 120, or a portion or an entirety of the electrical energy storage device 100. In one or more embodiments, the plurality of bus bars 134 may connect the electrochemical cells 120 together in a series via one or more cell-to-cell interconnect(s) 140. In some embodiments, the plurality of bus bars 134 may be intimately connected to the electrodes (not shown) of the electrochemical cells 120 of the electrical energy storage device 100. In various embodiments, the operation of the bus bars 134 may be under control of the battery management system 110, which is tasked with monitoring the voltage and temperature of the electrochemical cells 120 of the electrical energy storage device 100. The heat applied to one or more bus bars 134 may be channeled into one or more electrochemical cells 120 or heat up a portion or an entirety of the electrical energy storage device 100.

In one or more embodiments, the electrical energy storage device 100 may include an enclosure 150 to enclose the electrical energy storage device 100. The enclosure 150 may be configured to house the electrochemical cells 120 and the heating module 130, and any accompanying miscellaneous and ancillary electrical or electronic components. In various embodiments, the miscellaneous and ancillary electrical or electronic components may include a gated driver, an electrically operated switches, including but not limited to, for example, metal-oxide-semiconductor field-effect transistor (MOSFET) or a solid-state relay. In some embodiments, the internal control mechanism of the heating module 130 can be configured to work independently of an external control from outside the enclosure 150.

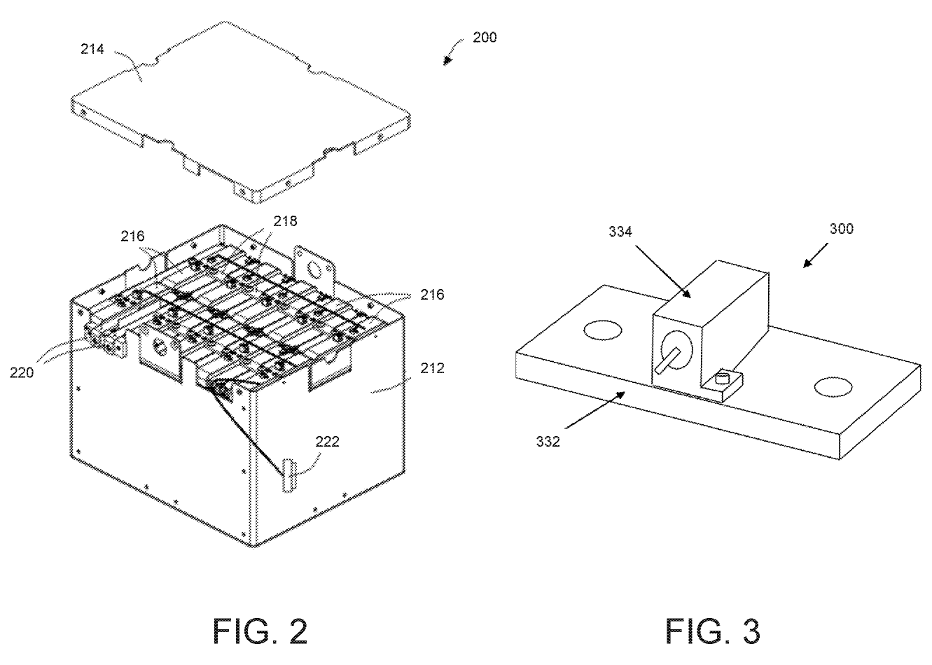

FIG. 2 illustrates an embodiment of an electrical energy storage device 200 as a battery module, in accordance with various embodiments. As illustrated in FIG. 2, the electrical energy storage device 200 includes one or more electrochemical cells 216 connected in series and/or parallel and are contained inside an enclosure 212 and enclosed by a removable lid 214, in accordance with one or more embodiments. In some embodiments, the electrical energy storage device 200 includes the electrochemical cells 216 connected in series by one or more bus bars 218 located in the enclosure 212. As illustrated in FIG. 2, the electrical energy storage device 200 includes power connections 220 (to one or more anodes and cathodes of the electrochemical cells 216) and a cable assembly 222, which can be configured to provide access to individual electrochemical cells 216 for measuring, for example, cell voltage and/or temperature.

FIG. 3 illustrates an embodiment of a heating module 300 for use within an electrical energy storage device, in accordance with various embodiments. As illustrated in FIG. 3, the heating module 300 is a bus bar 332 fitted with a heating element 334, such as a chassis mount power resistor. In one or more embodiments, the heating element 334 may be a resistive heating wire. In various embodiments, the bus bar 332 can include a mechanically attached chassis mount power resistor (generally referred to herein as heating element 334).

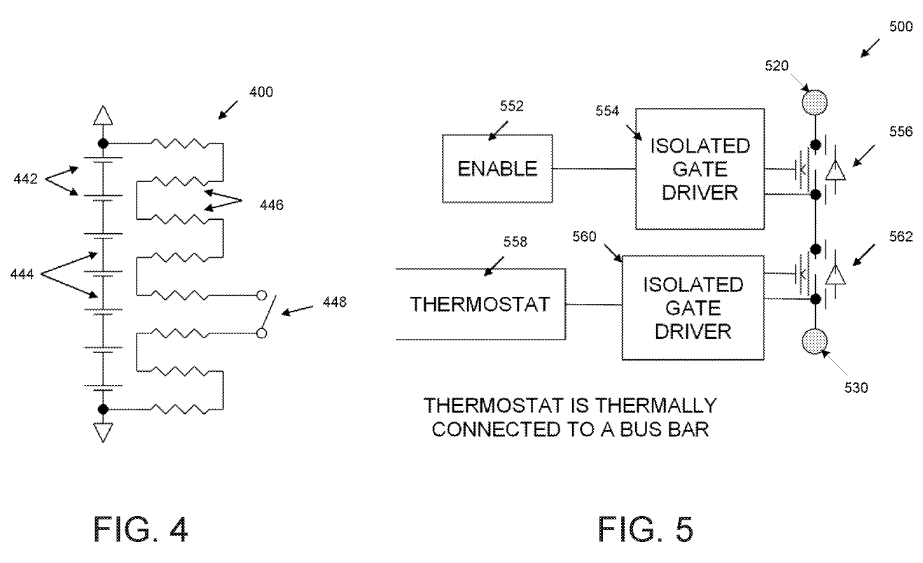

FIG. 4 illustrates a schematic circuit diagram of an electrical energy storage device 400 depicting interconnections between a plurality of electrochemical cells and heaters of a heating module, in accordance with various embodiments. As illustrated in FIG. 4, the schematic circuit diagram of the electrical energy storage device 400 is shown as a 7-cell electrochemical storage device unit comprising electrochemical cells 442, bus bars 444, and resistors 446, with respective connections therebetween. The resistors 446 represent the heating elements (hence can be referred to herein as heaters 446) that are connected in series and powered from the end terminals of the electrical energy storage device 400, in accordance with one or more embodiments. A switch 448 in FIG. 4 is shown to be placed somewhere in the string of resistors 446 in order to control the heater mechanism, as part of the battery management system described herein.

In various embodiments, the electrochemical cells 443 and heaters 446 with an electrically operated switch, such as a MOSFET or solid-state relay, to control heater operation within the electrical energy storage device 400. In some embodiments, the heating module may include a relay switch unit configured to control a current flow through a heating element of the resistors/heaters 446.

In various embodiments, the electrical energy storage device 400 may include one or more cell-to-cell interconnects that are coupled to the heating module and configured to electrically interconnect at least two of the one or more electrochemical cells. As illustrated in FIG. 4, such electrical connections, such as, cell-to-cell interconnect(s) 140 as illustrated in FIG. 1, between the electrochemical cells 442 can be implemented by one or more bus bars 444 of the heating module (e.g., heating module 130) to which the resistors/heaters 446 are mounted, in accordance with one or more embodiments.

FIG. 5 illustrates an example schematic diagram of a control circuit 500 in a battery management system of an electrical energy storage device, in accordance with various embodiments. As illustrated in FIG. 5, the control circuit 500 can be used as a heater mechanism managed by the battery management system, such as the battery management system 110 of the electrical energy storage device 100 described with respect to FIG. 1. In one or more embodiments, the heater mechanism may be represented by a switch, such as switch 448 in FIG. 4, to which a first terminal may be connected to a positive terminal 520 of the battery, and a second terminal may be connected to a negative terminal 530 of a battery, such as, the electrical energy storage device 100 described with respect to FIG. 1.

In one or more embodiments, when the battery management system, which is tasked with monitoring electrochemical cell temperatures and voltages, determines that the electrochemical cells (e.g., electrochemical cells 120 or 216) are cooling off then it asserts a signal ENABLE 552 causing an isolated gate driver 554 to apply a voltage to the gate of a MOSFET 556, thereby placing it in a conductive state. In one or more embodiments, a second safety mechanism may include a thermostat (temperature sensor) 558, an isolated gate driver 560 and a MOSFET 562, which is driven on pending the temperature of the bus bar (e.g., bus bar 134, 218, or 332) does not exceed a set point of the thermostat 558, such as the minimum preset temperature and the maximum preset temperature as described with respect to FIG. 1. In other words, the heating module may include a redundant control unit configured to limit a bus bar temperature without a software control and without the external control from outside the enclosure.

In various embodiments, the set point of the thermostat 558 can be a minimum preset temperature of about -10 ºC, about -9 ºC, about -8 ºC, about -7 ºC, about -6 ºC, about -5 ºC, about -4 ºC, about -3 ºC, about -2 ºC, about -1 ºC, about 0 ºC, about 1 ºC, about 2 ºC, about 3 ºC, about 4 ºC, about 5 ºC, about 6 ºC, about 7 ºC, about 8 ºC, about 9 ºC, about 10 ºC, about 11 ºC, about 12 ºC, about 13 ºC, about 14 ºC, about 15 ºC, about 16 ºC, about 17 ºC, about 18 ºC, or about 19 ºC. In various embodiments, the set point of the thermostat 558 can be a maximum preset temperature of about 10 ºC, about 11 ºC, about 12 ºC, about 13 ºC, about 14 ºC, about 15 ºC, about 16 ºC, about 17 ºC, about 18 ºC, about 19 ºC, about 20 ºC, about 21 ºC, about 22 ºC, about 23 ºC, about 24 ºC, about 25 ºC, about 26 ºC, about 27 ºC, about 28 ºC, about 29 ºC, about 30 ºC, about 31 ºC, about 32 ºC, about 33 ºC, about 34 ºC, about 35 ºC, about 36 ºC, about 37 ºC, about 38 ºC, or about 39 ºC.

In one or more embodiments, the transistors 556 and 562 can be in a conductive state. When both transistors 556 and 562 are in a conductive state, the current that flows through the resistors can occur, thereby causing heat to be generated via a resistor (e.g., heating element 136, heating element 334, or resistor/heater 446) and conducted into the electrochemical cells. In various embodiments, if all the electrochemical cells in the electrical energy storage device are similar, they present the same thermal mass to the bus bars, and a single control circuit 500 may be used to limit the bus bars to regulate the temperature of the electrochemical cells individually or the electrical energy storage device. In various embodiments, the heating module (or heating element 136, heating element 334, or resistor/heater 446) may be in thermal contact with at least two of the one or more electrochemical cells in the electrical energy storage device. In various embodiments, the heating module (or heating element 136, heating element 334, or resistor/heater 446) may be in physical contact with one or more electrodes of the one or more electrochemical cells in the electrical energy storage device.

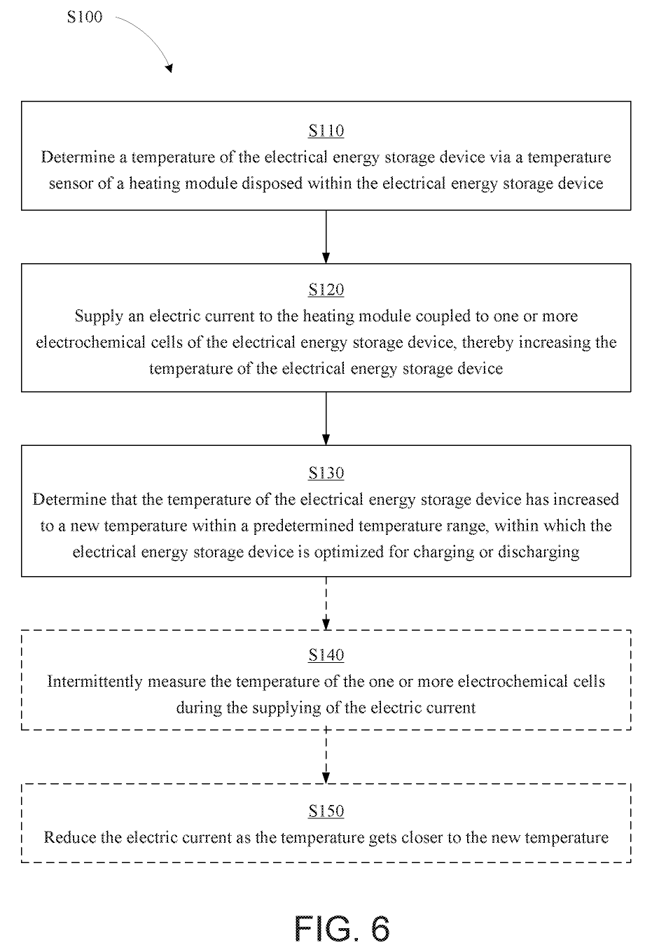

FIG. 6 illustrates a method S100 of operating an electrical energy storage device, in accordance with various embodiments. As illustrated in FIG. 6, the method S100 includes, at step S110, determining a temperature of the electrical energy storage device via a temperature sensor of a heating module disposed within the electrical energy storage device; at step S120, supplying an electric current to the heating module coupled to one or more electrochemical cells of the electrical energy storage device, thereby increasing the temperature of the electrical energy storage device; and at step S130, determining that the temperature of the electrical energy storage device has increased to a new temperature within a predetermined temperature range, within which the electrical energy storage device is optimized for charging or discharging.

In one or more embodiments of the method S100, the temperature sensor, such as thermostat 558, can be configured to monitor a temperature of the one or more electrochemical cells.

In one or more embodiments, the method S100 may further include, optionally, at step S140, intermittently measuring the temperature of the one or more electrochemical cells during the supplying of the electric current; and optionally at step S150, reducing the electric current as the temperature gets closer to the new temperature.

In one or more embodiments of the method S100, the electrical energy storage device may include an enclosure configured to house the one or more electrochemical cells and the heating module, and wherein the heating module is configured to operate without an external control from outside the enclosure. In one or more embodiments, the heating module may include a bus bar physically coupled to the one or more electrochemical cells of the electrical energy storage device. In one or more embodiments, the bus bar may include a heating element that includes a resistive heating wire.

In one or more embodiments, the heating module may further include a relay switch unit configured to control a current flow through the heating element, and/or a redundant control unit configured to limit a bus bar temperature without a software control and without the external control from outside the enclosure. In one or more embodiments, the heating module may be in thermal contact with at least two of the one or more electrochemical cells. In one or more embodiments, the heating module may be in physical contact with one or more electrodes of the one or more electrochemical cells

In one or more embodiments, the electrical energy storage device may include a cell-to-cell interconnect coupled to the heating module and configured to electrically interconnect at least two of the one or more electrochemical cells. In one or more embodiments, the electrical energy storage device may further include a removable lid configured to enclose the one or more electrochemical cells and the heating module within the enclosure, thereby creating an enclosed system for the electrical energy storage device.

In one or more embodiments, the heating module may be further configured to regulate a temperature of the enclosed system for the electrical energy storage device to be within the predetermined temperature range during charging or discharging of the electrical energy storage device.

In various embodiments of the disclosure, an energy storage module is described. The module may include a heating assembly coupled to one or more electrochemical cells. The heating assembly may include a heating member and a heating element coupled to the heating member, and an internal control mechanism configured to control the heating assembly. In one or more embodiments, the internal control mechanism may include a self-limiting configuration to maintain a minimum temperature of the one or more electrochemical cells.

In one or more embodiments, the heating member may include a bus bar configured to hold the heating element, wherein the heating element is configured to work as a resistive heater. In one or more embodiments, the internal control mechanism may include a circuit or an integrated circuit configured to control a current flow through the heating element via a relay switch, a gate driver, and a transistor. In one or more embodiments, the internal control mechanism may include a redundant control unit configured to limit a bus bar temperature without a software control. In one or more embodiments, the heating member may be in thermal contact with at least two of the one or more electrochemical cells. In one or more embodiments, the heating member may be in physical contact with one or more electrodes of the one or more electrochemical cells.

In one or more embodiments, the module may further include a cell-to-cell interconnect that is coupled to the heating assembly and configured to electrically interconnect at least two of the one or more electrochemical cells. In one or more embodiments, the module may be disposed within an enclosure, thereby creating an enclosed system for the module, wherein the heating assembly is further configured to maintain the minimum temperature of the one or more electrochemical cells during charging or discharging of the one or more electrochemical cells.

### RECITATION OF EMBODIMENTS

Embodiment 1. An electrical energy storage device, comprising: one or more electrochemical cells; and a heating module coupled to, and configured to regulate a temperature of, the one or more electrochemical cells, wherein the heating module is configured to function as an internal control mechanism configured to regulate (limiting the temperature drop or a trigger configured to turn on exceeding a preset temperature or range) the temperature of the one or more electrochemical cells within a predetermined temperature range having a minimum preset temperature and a maximum preset temperature.

Embodiment 2. The electrical energy storage device of Embodiment 1, wherein the heating module comprises a temperature sensor disposed approximate the one or more electrochemical cells, and wherein the temperature sensor is configured to monitor a temperature of the one or more electrochemical cells.

Embodiment 3. The electrical energy storage device of Embodiments 1 or 2, further comprising: an enclosure configured to house the one or more electrochemical cells and the heating module, wherein the internal control mechanism of the heating module is independent of an external control from outside the enclosure.

Embodiment 4. The electrical energy storage device of any of Embodiments 1-3, wherein the heating module further comprises a bus bar physically coupled to a heating element.

Embodiment 5. The electrical energy storage device of Embodiment 4, wherein the heating element comprises a resistive heating wire.

Embodiment 6. The electrical energy storage device of Embodiments 4 or 5, wherein the heating module further comprises a relay switch unit configured to control a current flow through the heating element.

Embodiment 7. The electrical energy storage device of any of Embodiments 4-6, wherein the heating module further comprises a redundant control unit configured to limit a bus bar temperature without a software control and without the external control from outside the enclosure.

Embodiment 8. The electrical energy storage device of any of Embodiments 1-7, wherein the heating module is in thermal contact with at least two of the one or more electrochemical cells.

Embodiment 9. The electrical energy storage device of any of Embodiments 1-8, wherein the heating module is in physical contact with one or more electrodes of the one or more electrochemical cells.

Embodiment 10. The electrical energy storage device of any of Embodiments 1-9, further comprising: a cell-to-cell interconnect coupled to the heating module and configured to electrically interconnect at least two of the one or more electrochemical cells.

Embodiment 11. The electrical energy storage device of any of Embodiments 1-10, further comprising: a removable lid configured to enclose the one or more electrochemical cells and the heating module within the enclosure, thereby creating an enclosed system for the electrical energy storage device, wherein the heating module is further configured to regulate a temperature of the electrical energy storage device to be within the predetermined temperature range during charging or discharging of the electrical energy storage device.

Embodiment 12. A module, comprising: a heating assembly coupled to one or more electrochemical cells, the heating assembly comprising a heating member and a heating element coupled to the heating member; and an internal control mechanism configured to control the heating assembly, the internal control mechanism comprising a self-limiting configuration to maintain a minimum temperature of the one or more electrochemical cells.

Embodiment 13. The module of Embodiment 12, wherein the heating member comprises a bus bar configured to hold the heating element.

Embodiment 14. The module of Embodiments 12 or 13, wherein the heating element is configured to work as a resistive heater.

Embodiment 15. The module of any of Embodiments 12-14, wherein the internal control mechanism further comprises a circuit or an integrated circuit configured to control a current flow through the heating element via a relay switch, a gate driver, and a transistor.

Embodiment 16. The module of Embodiment 15, wherein the internal control mechanism further comprises a redundant control unit configured to limit a bus bar temperature without a software control.

Embodiment 17. The module of any of Embodiments 12-16, wherein the heating member is in thermal contact with at least two of the one or more electrochemical cells.

Embodiment 18. The module of any of Embodiments 12-17, wherein the heating element is in physical contact with one or more electrodes of the one or more electrochemical cells.

Embodiment 19. The module of any of Embodiments 12-18, further comprising: a cell-to-cell interconnect coupled to the heating assembly and configured to electrically interconnect at least two of the one or more electrochemical cells.

Embodiment 20. The module of any of Embodiments 12-19, wherein the module is disposed within an enclosure, thereby creating an enclosed system for the module, wherein the heating assembly is further configured to maintain the minimum temperature of the one or more electrochemical cells during charging or discharging of the one or more electrochemical cells.

Embodiment 21. A method of operating an electrical energy storage device, comprising: determining a temperature of the electrical energy storage device via a temperature sensor of a heating module disposed within the electrical energy storage device; supplying an electric current to the heating module coupled to one or more electrochemical cells of the electrical energy storage device, thereby increasing the temperature of the electrical energy storage device; and determining that the temperature of the electrical energy storage device has increased to a new temperature within a predetermined temperature range, within which the electrical energy storage device is optimized for charging or discharging.

Embodiment 22. The method of Embodiment 21, wherein the temperature sensor is configured to monitor a temperature of the one or more electrochemical cells.

Embodiment 23. The method of Embodiments 21 or 22, further comprising: intermittently measuring the temperature of the one or more electrochemical cells during the supplying of the electric current; and reducing the electric current as the temperature gets closer to the new temperature.

Embodiment 24. The method of any of Embodiments 21-23, wherein the electrical energy storage device comprises an enclosure configured to house the one or more electrochemical cells and the heating module, and wherein the heating module is configured to operate without an external control from outside the enclosure.

Embodiment 25. The method of any of Embodiments 21-24, wherein the heating module comprises a bus bar physically coupled to the one or more electrochemical cells of the electrical energy storage device.

Embodiment 26. The method of Embodiment 25, wherein the bus bar comprises a heating element that includes a resistive heating wire.

Embodiment 27. The method of Embodiment 26, wherein the heating module further comprises a relay switch unit configured to control a current flow through the heating element, and/or a redundant control unit configured to limit a bus bar temperature without a software control and without the external control from outside the enclosure.

Embodiment 28. The method of any of Embodiments 21-27, wherein the heating module is in thermal contact with at least two of the one or more electrochemical cells.

Embodiment 29. The method of any of Embodiments 21-28, wherein the heating module is in physical contact with one or more electrodes of the one or more electrochemical cells

Embodiment 30. The method of any of Embodiments 21-29, wherein the electrical energy storage device further comprises a cell-to-cell interconnect coupled to the heating module and configured to electrically interconnect at least two of the one or more electrochemical cells.

Embodiment 31. The method of any of Embodiments 24-30, wherein the electrical energy storage device further comprises a removable lid configured to enclose the one or more electrochemical cells and the heating module within the enclosure, thereby creating an enclosed system for the electrical energy storage device.

Embodiment 32. The method of Embodiment 31, wherein the heating module is further configured to regulate a temperature of the enclosed system for the electrical energy storage device to be within the predetermined temperature range during charging or discharging of the electrical energy storage device.

1. An electrical energy storage device, comprising:
one or more electrochemical cells; and
a heating module coupled to, and configured to regulate a temperature of, the one or more electrochemical cells, wherein the heating module is configured to function as an internal control mechanism configured to regulate the temperature of the one or more electrochemical cells within a predetermined temperature range having a minimum preset temperature and a maximum preset temperature.

2. The electrical energy storage device of claim 1, wherein the heating module comprises a temperature sensor disposed approximate the one or more electrochemical cells, and wherein the temperature sensor is configured to monitor a temperature of the one or more electrochemical cells.

3. The electrical energy storage device of claim 1, further comprising:
an enclosure configured to house the one or more electrochemical cells and the heating module, wherein the internal control mechanism of the heating module is independent of an external control from outside the enclosure.

4. The electrical energy storage device of claim 1, wherein the heating module further comprises a bus bar physically coupled to a heating element.

5. The electrical energy storage device of claim 4, wherein the heating element comprises a resistive heating wire.

6. The electrical energy storage device of claim 4, wherein the heating module further comprises a relay switch unit configured to control a current flow through the heating element.

7. The electrical energy storage device of claim 4, wherein the heating module further comprises a redundant control unit configured to limit a bus bar temperature and without the external control from outside the enclosure.

8. The electrical energy storage device of claim 1, wherein the heating module is in thermal contact with at least two of the one or more electrochemical cells.

9. The electrical energy storage device of claim 1, wherein the heating module is in physical contact with one or more electrodes of the one or more electrochemical cells.

10. The electrical energy storage device of claim 1, further comprising:
a cell-to-cell interconnect coupled to the heating module and configured to electrically interconnect at least two of the one or more electrochemical cells.

11. The electrical energy storage device of claim 1, further comprising:
a removable lid configured to enclose the one or more electrochemical cells and the heating module within the enclosure, thereby creating an enclosed system for the electrical energy storage device,
wherein the heating module is further configured to regulate a temperature of the electrical energy storage device to be within the predetermined temperature range during charging or discharging of the electrical energy storage device.

12. A module, comprising:
a heating assembly coupled to one or more electrochemical cells, the heating assembly comprising a heating member and a heating element coupled to the heating member; and
an internal control mechanism configured to control the heating assembly, the internal control mechanism comprising a self-limiting configuration to maintain a minimum temperature of the one or more electrochemical cells.

13. The module of claim 12, wherein the heating member comprises a bus bar configured to hold the heating element.

14. The module of claim 12, wherein the heating element is configured to work as a resistive heater.

15. A method of operating an electrical energy storage device, comprising:
determining a temperature of the electrical energy storage device via a temperature sensor of a heating module disposed within the electrical energy storage device;
supplying an electric current to the heating module coupled to one or more electrochemical cells of the electrical energy storage device, thereby increasing the temperature of the electrical energy storage device; and
determining that the temperature of the electrical energy storage device has increased to a new temperature within a predetermined temperature range, within which the electrical energy storage device is optimized for charging or discharging.

16. The method of claim 15, further comprising:
intermittently measuring the temperature of the one or more electrochemical cells during the supplying of the electric current; and
reducing the electric current as the temperature gets closer to the new temperature.

17. The method of claim 15, wherein the electrical energy storage device comprises an enclosure configured to house the one or more electrochemical cells and the heating module, and wherein the heating module is configured to operate without an external control from outside the enclosure.

18. The method of claim 15, wherein the heating module comprises a bus bar physically coupled to the one or more electrochemical cells of the electrical energy storage device.

19. The method of claim 18, wherein the bus bar comprises a heating element that includes a resistive heating wire.

20. The method of claim 19, wherein the heating module further comprises a relay switch unit configured to control a current flow through the heating element, and/or a redundant control unit configured to limit a bus bar temperature and without the external control from outside the enclosure.
